(19) United States
(12) Patent Application Publication
(10) Pub. No.: US 2005/0195419 A1
(43) Pub. Date: Sep. 8, 2005

(54) Printing method

(75) Inventor: Tytgat Bart, Bonheiden (BE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: AGFA-GEVAERT N.V., Mortsel (BE)

(21) Appl. No.: 11/057,658

(22) Filed: Feb. 14, 2005

Related U.S. Application Data
(60) Provisional application No. 60/554,486, filed on Mar. 19, 2004.

(30) Foreign Application Priority Data
Mar. 5, 2004 (EP) 04100903.6

(51) Int. Cl. G06F 15/00

(52) U.S. Cl. 358/1.13; 358/1.15

(57) ABSTRACT

Printing method wherein more than one logical printer is defined and wherein for a print job defined by a modality for a specific logical printer an associated set of pre-defined print characteristics and/or a predefined decision profile e.g. defining a back up printer, is selected and applied when performing the print job.

The application claims the benefit of U.S. Provisional Application No. 60/554,486 filed Mar. 19, 2004.

### FIELD OF THE INVENTION

The present invention relates to hard copy recording of medical images having different characteristics on a single physical printer or on one of a series of available printers on a data communication network.

### BACKGROUND OF THE INVENTION

Medical digital images acquired by a large number of image acquisition devices and pertaining to a lot of different types of medical examinations are commonly sent by a modality or a workstation to a printer for the generation of a hard copy.

The DICOM (Digital Imaging and Communications in Medicine) standards specify the conformance requirements for communicating medical digital images among printers, workstation, acquisition devices and servers.

Although a large number of items concerning data communication are prescribed in this protocol some items still need further consideration.

Depending on the type of image specific characteristics are imposed to the hard copy.

For example in case of a hard copy of a mammographic image care is taken that the transparent border at the thorax edge of the image is kept minimal so that the dazzling effect caused by the transparent area when left and right breast images are put side by side on a viewing box, is kept minimal.

Furthermore for mammographic images typically a higher maximum density value is set than for general radiography and a dedicated recording material is chosen.

In the DICOM Print protocol identification of an image as mammographic image is not possible.

Consequentially in practice mammographic images are commonly printed on a dedicated printer which is adjusted for this type of application.

Another issue with regard to medical images is that some regulations such as the HIPAA regulation (Health Insurance Portability and Accountability Act) in the United States require medical images to be communicated via a secured communication. However, not all modalities operate according to the requirements for secure communication. Consequentially state of the art mode of operation is to provide dedicated printers which are either adapted for secure or for non-secure communication.

A DICOM modality may send a DICOM print job to a printer without having assigned a value to a specific attribute which is required for optimal rendition of the hard copy image. Like wise a DICOM modality may have assigned a certain value to an attribute which value is however not optimally for hard copy rendition on the addressed printer.

A prior art solution is either to fill in a specific value for the missing value for the attribute or to overrule the set value by another value. However, the prior art only permits to fill out a single value or to overrule a set value by a single, preset value for a certain modality.

For example in case a printer has four different output trays, the above-described prior art solution does provide a procedure suitable to select each of these output trays.

Still another issue relates to the case wherein more than one printer is connected to a communication network via a printer server.

In this case a modality can specify a specific one of these printers to which the print job is to be transmitted.

For example a modality prepares a bit map of an image suitable for being printed on a printer capable of printing this format. However, if more than one printer is available it would be convenient to be able to re-route the print job in the event of printer failure or for the purpose of load balancing.

However, if the printer server does not have access to certain details on the print job it will not be able to select a suitable back up printer.

### SUMMARY OF THE INVENTION

To overcome the above-mentioned problems the present invention provides a method of printing medical images with different characteristics on a physical printer as set out in claim 1.

According to this method more than one logical printer is defined. A print job is defined by a modality for a specific logical printer. Next a set of pre-defined print characteristics associated with the combination of the modality and the logical printer is selected and applied to a physical printer when performing the print job.

More particularly this is implemented as follows in a specific embodiment based on the DICOM protocol.

Logical printers are defined as a DICOM Print Service Class Providers with associated Called Application Entity Title and occasionally port number. A modality has a Calling Application Entity title.

For a combination of Calling Application Entity Title, called Application Entity Title (and occasionally port number) a DICOM Host profile with specific DICOM settings is defined in advance. These settings are selected and applied to the physical printer to which the print job is sent.

In the context of the present invention the following terms are to be interpreted as explained below.

A modality refers to an image acquisition device generating a (digital) signal representation of an image or alternatively a workstation.

DICOM Print Server is a software component that administers the different DICOM print service class providers and makes the link to the DICOM host profile and the decision table referred to below.

When reference is made to a ‘printer server’ reference is made to a product which controls the operation of a plurality of individual printers (occasionally of different types) and which sends incoming print jobs to these printers taking into account a number of rules. With regard to a modality this printer server behaves as a printer having all capabilities of the individual printers.

Examples of different characteristics of images are the type of image (mammographic image, general radiography image), the kind of transmission used for an image (secure, non-secure) etc.

Examples of print characteristics are the lay out of an image, the minimal/maximal density of an image etc.

Another aspect of the present invention relates to a method of printing medical images with different characteristics on one of a series of physical printers. Also in this case more than one logical printer is defined and for a print job defined by a modality for a specific logical printer a pre-defined decision profile associated with said modality and said logical printer is selected and applied when performing the print job.

Additionally for a print job defined by a modality for a specific logical printer an associated set of pre-defined print characteristics can be selected—as has been described higher—and applied to said physical printer when performing the print job.

More particularly the above-described second aspect of the present invention is implemented as follows in a specific embodiment based on the DICOM print protocol.

At least one logical printer is defined as a DICOM Print Service Class Provider with associated Called Application Entity Title occasionally supplemented with a port number). For a combination of a Calling Application Entity Title defining a modality, a called Application Entity Title a unique key is defined which points to an entry in a decision table. The entry in the decision table defines at least a printer for performing the print job. Additionally it may define a back up printer or a printer to which the print job is to be sent in case load balancing is applied.

Further advantages and embodiments of the present invention will become apparent from the following description [and drawings].

### BRIEF DESCRIPTION OF THE DRAWINGS

FIG. 1 generally illustrates the use of a DICOM print server in accordance with the present invention in an environment in which modalities are coupled to a printer or to a printer server on a hospital data communication network,

FIG. 2 illustrates the use of a DICOM print server and associated DICOM host profile in a printer,

FIG. 3 illustrates the use of a DICOM print server in a printer server controlling more than one physical printer.

### DETAILED DESCRIPTION OF THE INVENTION

FIG. 1 relates to a hospital data communication network to which a plurality of modalities (in this particular example there are two modalities) and at least one printer such as a thermal printer are coupled. The modalities are programmed to communicate with the remote printer over the hospital network preferably in conformance with the DICOM standard.

The modalities run the DICOM print SCU (service class user) software component. The service class users are identified according to the DICOM protocol by a unique “calling Application Entity Title”.

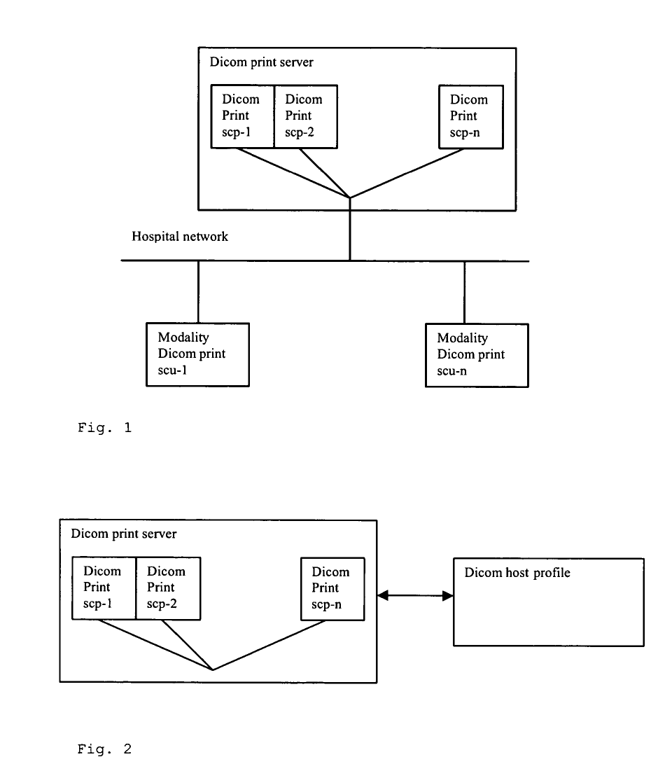

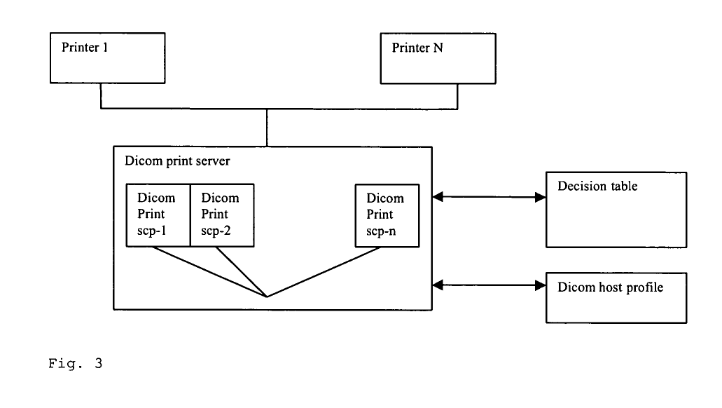

A printer or a printer server (see explanation with regard to FIGS. 2 and 3) runs a software component called DICOM Print Server.

DICOM Print Server is a software component that initiates the operation of different DICOM Print Service Class Providers (SCP) and links the DICOM Print service class users to one of a series of DICOM Print Service Class Providers.

In a first embodiment illustrated in FIG. 2, the DICOM Print Server is used in printer coupled to the modality via a hospital data communication network.

Each of the DICOM Print SCP's defined by the DICOM Print Server is uniquely defined by a ‘Called Application Entity title’ and occasionally also a port number.

According to the present invention for each combination of a “calling Application Entity title”, a “called application entity title” (occasionally supplemented by a port number), a unique key is defined. This unique key points to a DICOM host profile with specific DICOM settings.

Such specific DICOM settings are for example additions to what is sent by a modality, or data overruling settings sent by the modality etc.).

The DICOM host profile identified for the combination of Calling AE Title, Called AE Title and occassionally a port number is applied when the settings of the printer are adjusted in order to execute the print job sent by the modality to the printer.

If a modality defines a print job, the SCU defines a Called AE Title and a port number and sends the job to the printer where the DICOM Print Server software retrieves the DICOM host profile corresponding with the combination of calling AE title, called AE title and port number.

For example suppose a mammographic image acquired by a modality is to be printed on a thermal printer that is not a dedicated mammography printer and that is accordingly not adjusted to the specific requirements for mammographic images such as high maximum density, small transparent boarders at thorax edge etc.

Since the DICOM protocol does not provide an identification of the fact that the image is a mammographic image, the host profile is set up so that it comprises a flag the specific value of which identified whether or not the sent image is a mammographic image. In case the flag identifies that the image indeed is a mammographic image, additional printer characteristics that are typical for mammographic images can be added to the print job such as details on the location of the image relative to the borders of the print material print format or an identification of the recording material to be selected (in DICOM terms: medium size and film type) or characteristics on the required maximum density etc.

FIG. 3 relates to an embodiment in which modalities are coupled to a data communication network to which also one or more printers are coupled via a hard ware printer server.

In this embodiment a DICOM Print Server software component is running on the printer server.

DICOM Print Server defines a number of DICOM Print service class providers (SCP).

Each of these DICOM Print SCP's is uniquely defined by a ‘Called Application Entity title’ and occasionally also a port number.

According to the present invention also in this embodiment for each combination of a “calling Application Entity title”, a “called application entity title” and a port number, a unique key is defined.

In this embodiment this unique key points to an entry in a decision table. This entry may for example indicate the printer to which the print job is to be sent to or alternatively may define an action to be taken. Examples of such actions are actions regarding load balancing, identification of a back up printer etc.

For example the decision table may indicate that for SCP 1 the primary printer is printer X and the back up printer is printer Y. Another example of decisions which may be defined in the decision table is that for SCP 2 a load balancing action is defined between printer A and printer B. This means for example that once the print queue of printer A exceeds a number of waiting print jobs the print jobs in excess of that number are transferred to printer B. Other examples may be envisaged.

In addition to this decision table, a DICOM host profile similar to that described with regard to the first embodiment may be defined so that for a combination of a calling AE title and Called AE title and occasionally also a Port number, a unique key is defined which points to a specific entry in a user host profile where specific DICOM settings for that unique key can be found.

1. Method of printing medical images with different characteristics on a physical printer characterised in that
more than one logical printer is defined,
for a print job defined by a modality for a specific logical printer an associated set of pre-defined print characteristics is selected and applied to said physical printer when performing said print job.

2. Method according to claim 1 wherein a logical printer is defined as a DICOM print Service Class Provider with associated Called Application Entity Title and that with a combination of at least a Calling AE title defining said modality and said called AE title a DICOM Host profile is selected with specific DICOM settings, which settings are applied to said printer when performing said print job.

3. Method of printing medical images with different characteristics on one of a series of physical printers characterised in that
more than one logical printer is defined,
for a print job defined by a modality for a specific logical printer a pre-defined decision profile associated with said modality and said logical printer is selected and applied when performing said print job.

4. Method according to claim 3 wherein for a print job defined by a modality for a specific logical printer an associated set of pre-defined print characteristics is selected and applied to said physical printer when performing said print job.

5. Method according to claim 3 wherein a logical printer is defined as a DICOM Print Service Class Provider with associated Called Application Entity Title and that for a combination of Calling AE Title defining a modality, called AE title a unique key is defined which points to an entry in a decision table, said entry at least defining a printer for performing said print job.

6. Method according to claim 4 wherein a logical printer is defined as a DICOM print Service Class Provider with associated Called Application Entity Title and that with a combination of at least a Calling AE title defining said modality and said called AE title a DICOM Host profile is selected with specific DICOM settings, which settings are applied to said printer when performing said print job.

7. Method according to claim 3 wherein said decision profile comprises for a combination of Calling Application Entity Title and Called Application Entity Title of a back up printer.

8. Method according to claim 3 wherein said decision profile comprises for a combination of Calling Application Entity Title, Called Application Entity Title an identification of a printer to be used for load balancing purpose.
